(19) United States
(12) Patent Application Publication
(10) Pub. No.: US 2016/0140407 A1
(43) Pub. Date: May 19, 2016

(54) SYSTEM AND METHOD FOR BIOMETRIC IDENTIFICATION

(71) Applicant: QUANTUMRGB LTD., Haifa (IL)

(72) Inventors: Henia VEKSLER, Bik'at Bet HaKerem (IL); Shai AMISAR, Tel Aviv (IL); Ronen RADOMSKI, Haifa (IL)

(21) Appl. No.: 14/899,315

(22) PCT Filed: Jun. 17, 2014
(86) PCT No.: PCT/IL2014/050547

§ 371 Date: Dec. 17, 2015

Related U.S. Application Data
(60) Provisional application No. 61/835,665, filed on Jun. 17, 2013.

(51) Int. Cl. G06K 9/00; G06K 9/46; G06T 7/00; G06K 9/62

(52) U.S. Cl. CPC G06K 9/00926; G06K 9/6215; G06K 9/4661; G06T 7/0085; G06K 9/4604; G06T 7/0042; G06T 2207/20048; G06T 2207/20144; G06T 2207/30196

(57) ABSTRACT

The present invention relates to a method and system for generating and comparing a biometric singular signature of a person comprising the steps of a) obtaining a first image of a person; b) obtaining a hair portion image of the person; c) transforming the hair portion image into its frequency domain image and optionally saving said frequency domain image in a database. Additional applications associated to the method are disclosed.

### FIELD OF THE INVENTION

The present invention relates to the field of biometric identification through image and signal processing. More particularly, the present invention relates to the identification of a person by spectrum analyzing of a person's hair.

### BACKGROUND OF THE INVENTION

Current biometric methods for the image identification of a subject are based on clear facial, iris, handprints etc., and require special equipment and clear photographs from specially installed cameras. All current biometric methods are ineffective when used with standard security cameras since they have a relatively low resolution, they are placed at generally high angles and function with uncontrolled lighting conditions. One of the outcomes of these drawbacks is that the people identification from these cameras are inefficient. Today, tracking methods are based on the fact that a camera can track certain objects until the objects exit that camera's field of view. When a person exits a certain camera's field of view and enters an adjacent camera's field of view the tracking of the first camera is ceased and a new tracking begins by the second camera. The tracking of the second camera is implemented independently, regardless of the first camera tracking. Automatic continuous tracking of a certain object from one camera's field of view to another camera's field of view includes complicated tracking applications which are inaccurate and frequently tend to malfunction. Furthermore, a tracking method which enables tracking even when a subject exits all the camera fields of view (or is obscured by another object) and returns later on, is highly needed.

Furthermore, there is a need for tracking the whereabouts of a person when analyzing a post event video and looking for the timeline of events regarding a specific person. Today, the only solution is to have a security analyst view the video and mark manually the appearance of a certain individual.

FIG. 1 illustrates a prior art series of cameras (50a-50e) aiming at covering the surrounding field of view of a warehouse. Each camera covers a certain field of view. Each camera's adjacent camera covers a field of view adjacent to its camera's field of view. Security personnel viewing the camera filming recording at a remote location would have difficulties tracking a suspicious subject when the suspicious subject crosses one camera's field of view to another. Current systems allow marking a subject on the camera viewing screen. Then the subject is tracked using appropriate applications until the subject exits the camera's field of view. The security personnel would have to mark the suspicious subject again on the screen of the adjacent camera for continuation tracking, what could be very confusing due to the fact that people look alike on a security camera. Furthermore, constant tracking along a series of cameras requires frequent manual interference.

Also, means are required for tracking and identifying a subject even if he exits all system cameras field of view for a long period of time.

It is therefore an object of the present invention to provide a method and means for coherent identification of a person with a novel biometric quality based on the unique qualities of human hair and head contour and morphology.

It is yet another object of the present invention to provide a method and means for generating a digital signature with high coherence for a specific person based on his hair and skull structure and using said signature for various video analysis tasks.

It is yet another object of the present invention to provide a method and means for performing a signature on a subject and means for identifying the signed subject later on when returning to system cameras fields of view.

It is yet another object of the present invention to provide means to analyze a post event video to determine the whereabouts of a specific person during the Video run time.

It is yet another object of the present invention to generate a coherent signature for a person from a set of photographs and search for that specific person in a video, generated in a different time, on-line or post event analysis.

Other objects and advantages of the present invention will become apparent as the description proceeds.

### SUMMARY OF THE INVENTION

The present invention relates to a system and method for analyzing and processing a photographic image of a person such that a person's hair features (or skull structure or both) are obtained and transformed into the frequency domain. The obtained hair frequency features of a person are usually the same on a specific head orientation of the person. The amount of hair, the thickness of the hair, etc. are similar at various orientations, and a positive identification of a person may be made even with different head orientations. Various image processing means are used to obtain an optimal portion of the hair and accordingly obtain a good frequency domain representation unique only to that person indicating the person. When compared with another image of that person (that was processed accordingly and produced a frequency domain representation) the coherence of the two frequency representations is found to be high giving a positive match between the two.

The present invention relates to a method for identifying a person comprising the following steps:
A) obtaining an image of a person;
B) obtaining a hair or skull portion of the person in the image;
C) Transforming said hair or skull portion image into the frequency domain and saving it in a database;
D) Comparing the obtained frequency domain image of step C with frequency domain images in the database, wherein an identification result is deemed to be positive when the coherence between both compared frequency domain images is above a certain threshold.

The present invention relates to a system comprising one or more cameras connected to processing means, wherein the processing means comprises:
A) a database;
B) a transformation to frequency domain unit;
C) a comparing coherence function unit.

The present invention relates to a method for generating and comparing a biometric singular signature of a person comprising the following steps:
A) obtaining a first image of a person;
B) obtaining a hair portion image of the person;
C) transforming the hair portion image into its frequency domain image and optionally saving said frequency domain image in a database.

Preferably, the method further comprises a step of identification by comparing the obtained frequency domain image of step C with frequency domain images in the database, wherein an identification result is deemed to be positive when the coherence between both compared frequency domain images is above a certain threshold.

Preferably, the hair portion image of step B) is obtained by further comprising one or more of the following steps:
a. obtaining a second image from a camera taken shortly after or shortly before the first image;
b. transforming the first and second images into 1-D signals;
c. performing a 2-D median function on the signals of step b;
d. reconstructing a background 2-D image featuring the signal of step c and the size of the first and second image;
e. obtaining the first or second image and adjusting its luminance to the luminance of the background image of step d; wherein obtained image comprises a bounded portion;
f. subtracting the image of step e from the image of step d (or vice versa);
g. perform an absolute value function on the image of step f to receive an object foreground;
h. obtaining a new image being a portion of the object foreground, wherein said portion of the object foreground is at the location corresponding to the location of the bounded portion mentioned in step e.
i. performing a FIR convolution on the image of step h with a head portion template to receive the image of step h further comprising an additional dimension with coefficient values corresponding to each image pixel;
j. obtaining a new image being a portion of the image of step i, wherein said portion of the image of step i comprises the pixels with the corresponding coefficient values above a threshold;
k. performing a FIR convolution on the image of step j with a hair portion template to receive the image of step j further comprising an additional dimension with coefficient values corresponding to each image pixel;
l. obtaining a new image being a portion of the image of step k, wherein said portion of the image of step k comprises the pixels with the corresponding coefficient values above a threshold.

Preferably, step C comprises performing a signature by saving the frequency domain image in the database and providing it with identification.

Preferably, the image of step g is further processed by transferring the image into a 1-D signal, and passing the signal through a FIR filter which further filters noises of background portions, and reconstructing a 2-D image featuring the output signal of the FIR filter and the size of the image of step g.

Preferably, a contrast adjustment is performed on the object foreground after step g.

Preferably, the image of step l is further modified by assigning artificial background values to the pixels with the corresponding coefficient values below the threshold.

The present invention relates to a method for identifying a person comprising the following steps:
A) obtaining a first image of a person;
B) obtaining a hair portion image of the person further comprising at least one of the following steps:
a. obtaining a second image from a camera taken shortly after or shortly before the first image;
b. transforming the first and second images into 1-D signals;
c. performing a 2-D median function on the signals of step b;
d. reconstructing a background 2-D image featuring the signal of step c and the size of the first and second image;
e. obtaining the first or second image and adjusting its luminance to the luminance of the background image of step d; wherein obtained image comprises a bounded portion;
f. subtracting the image of step e from the image of step d (or vice versa);
g. perform an absolute value function on the image of step f to receive an object foreground;
h. obtaining a new image being a portion of the object foreground, wherein said portion of the object foreground is at the location corresponding to the location of the bounded portion mentioned in step e.
i. performing a FIR convolution on the image of step h with a head portion template to receive the image of step h further comprising an additional dimension with coefficient values corresponding to each image pixel;
j. obtaining a new image being a portion of the image of step i, wherein said portion of the image of step i comprises the pixels with the corresponding coefficient values above a threshold;
k. performing a FIR convolution on the image of step j with a hair portion template to receive the image of step j further comprising an additional dimension with coefficient values corresponding to each image pixel;
l. obtaining a new image being a portion of the image of step k, wherein said portion of the image of step k comprises the pixels with the corresponding coefficient values above a threshold.
m. bounding the hair area;
n. dividing the hair area into three zones;
o. obtaining a contour strip from each of said zones, wherein said strip comprises a line of adjacent pixels in a certain direction from one edge of the zone to another;
p. calculating the ratio between intensity values of the highest position pixel in the contour strip and the lowest position pixel in the contour strip;
q. transforming the strips into frequency domain images and optionally saving said frequency domain images in a database being assigned to a certain subject;
r. comparing one of the obtained frequency domain images with frequency domain images of a subject in the database, wherein both frequency domain images compared are those with the closest intensity ratios; and wherein an identification result is deemed to be positive when the coherence between the two compared frequency domain images is above a first threshold and deemed to be negative when the coherence between the two compared frequency domain images is bellow a second threshold.

Preferably, if in step r the coherence result is between the first and second thresholds the following steps are taken:
s. obtaining a new contour strip by slightly shifting the obtained contour strip of step o;
t. transforming the new contour strip into the frequency domain and compared it with the same frequency domain strip of the database subject as in step r; wherein an identification result is deemed to be positive when the coherence between the two compared frequency domain images is above a first threshold and deemed to be negative when the coherence between the two compared frequency domain images is bellow a second threshold;
u. if in step t the coherence result is between the first and second thresholds, repeating steps s-u.

The present invention relates to a method for tracking a person, comprising at least the first 3 of the following steps:
A) obtaining an image of a person from a video camera;
B) obtaining a hair portion of the person in the image;
C) transforming the hair portion image into the frequency domain and saving it in a database;
D) dividing the image of step B into an array of groups of pixels;
E) transforming each group of step D into the frequency domain;
F) comparing the coherence between each group frequency domain of step E and the frequency image of step C;
G) obtaining the group with the highest coherence closest to the image of step C;
H) obtaining the consecutive frame of the camera (or number of frames);
I) dividing the image of step H into an array of groups of pixels similar to the array of step D, and mark the surrounding groups of the location of the highest coherence group of its previous frame (or previous number of frames);
J) transforming each group of step I into the frequency domain;
K) comparing the coherence between each group frequency domain of step J and the frequency image of step C (or the previous frame(s) highest coherence group);
L) obtaining the group with the highest coherence closest to the image of step C (or the previous frame(s) highest coherence group);
M) if the coherence of step L is above a threshold, then steps H-M are repeated; if the coherence of step L is beneath a threshold, then the tracking ceases.

The present invention relates to a system comprising one or more cameras connected to processing means,
wherein the processing means comprises:
   A) a database;
   B) a transformation to frequency domain unit;
   C) a comparing frequency coherence function unit.

The present invention relates to a method for generating a singular biometric signature comprising analyzing the hair/head structure of a given person in the frequency domain.

Preferably, the hair/head structure analyzed is one or more contours of the head.

Preferably, the method further comprises a step of coherence comparison between two signatures made according to claim 12 obtained from two different photographs.

Preferably, the method further comprises the step of calculating the intensity ratio between the intensity of the highest pixel in the contour and the intensity of the lowest pixel in the contour.

Preferably, the method further comprises the step of comparing the ratio calculated according to the above between two sets of contours from at least two different photographs.

Preferably, the method further comprises comparing only the two contours with the highest coherence of the intensity ratios.

The present invention relates to a system comprising two or more cameras connected to processing means,

wherein the processing means are configured to generate biometric signatures based on head/hair morphology of images obtained from said two or more cameras;
and configured to compare a signature from one camera to another camera to determine continuation of tracking.

### BRIEF DESCRIPTION OF THE DRAWINGS

The present invention is illustrated by way of example in the accompanying drawings, in which similar references consistently indicate similar elements and in which:

FIG. 1 illustrates a prior art system.

FIG. 2 illustrates an embodiment of the system of the present invention.

FIG. 3 illustrates a processing stage of the present invention.

FIGS. 4A-4B illustrate processing stages of the present invention.

FIGS. 4C-4D illustrate an example of the processing stage of FIG. 4B.

FIGS. 5-7 illustrate processing stages of the present invention

FIG. 8 illustrates an embodiment of the ROIs of the present invention.

FIGS. 9A-9C, 10A-10C, 11A-11C, illustrate working examples of the present invention.

FIGS. 12A-12C illustrate examples of the spectral analysis.

FIGS. 13A-13B illustrate properties of an example of a Wavelet template.

FIGS. 14A-14B illustrate two positions of a subject.

FIGS. 15A-15B illustrate examples of a contour strips.

FIGS. 16A-16C illustrate a working example of an embodiment of the present invention.

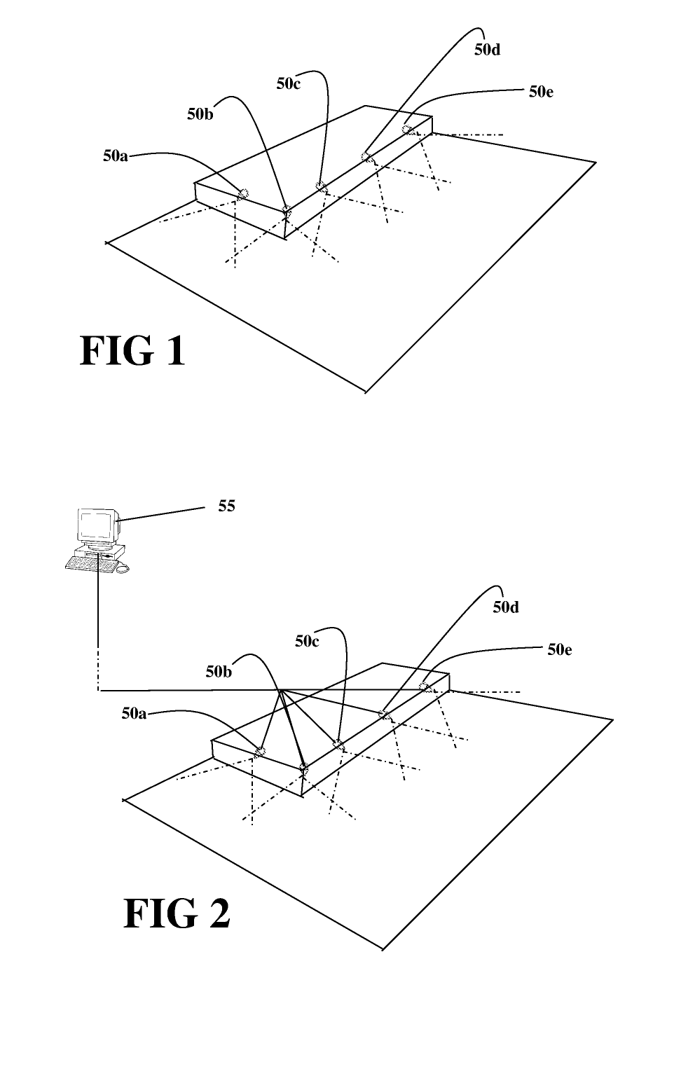

### DETAILED DESCRIPTION OF THE INVENTION

The present invention relates to a system that can identify a person according to a portion of his hair. It was found that the spectrum in the frequency domain of the human hair and the skull structure are influenced from various parameters that make the signature unique and singular per a given person. The color of the hair, thickness, number of hairs per given area are highly influential on the signal. The skull structure is also unique and changes the spectrum to form a unique spectrum by the general angle of the skull and the distribution of the hair on it. It's well known that the surface area of a given object is influential on the overall spectrum in the frequency domain.

Initially, the system analyzes an image portion of the hair of a subject and marks him with a signature. The system can then identify him again when obtaining additional images of the subject, analyze the additional images and compare with the initial image/signature.

The present invention system is especially beneficial for working with security cameras as they are usually installed at a high location to prevent any contact with pedestrians. From the high position that they are installed they have a better view of the hair portion of a person. Due to the fact that face recognition is very limited because of the high location of cameras, the present invention hair recognition method is in fact very efficient because of the high cameras.

According to one implementation, the present invention relates to a system comprising one or more cameras, such as standard security cameras (e.g. standard security video cameras). FIG. 2 illustrates an embodiment of the invention, wherein a series of cameras (50a-50e) are placed on top of a building aiming at covering the surrounding of a building (e.g. a warehouse building). Each camera covers a certain field of view adjacent to the adjacent camera's field of view. Security personnel can view the cameras filming recordings at a remote location. The system enables tracking capabilities and allows security personnel to mark a subject on the camera viewing screen for tracking said subject, using appropriate tracking applications such as “Six Sense” by NESS technologies, or such as MATLAB tracking application.

The one or more cameras 50a-50e are connected to processing means 55 such as a standard computer. The processing means 55 are adapted to take sample images of a subject and to analyze the subject hair properties in the frequency domain. The subject is marked with a signature and stored in a database. The system provides the ability such that when the subject enters the field of view of another camera, or disappears and returns to the same camera field of view, the subject hair is analyzed again and compared with the system subject hair database. The system can then match between the new measured properties and the database and mark the new image subject as one of the database's signatured subjects and inform the personnel of the positive identification.

According to a preferred embodiment of the present invention, the analysis of the images and the signature are implemented as follows.

First Stage—Obtaining the Background of the Image

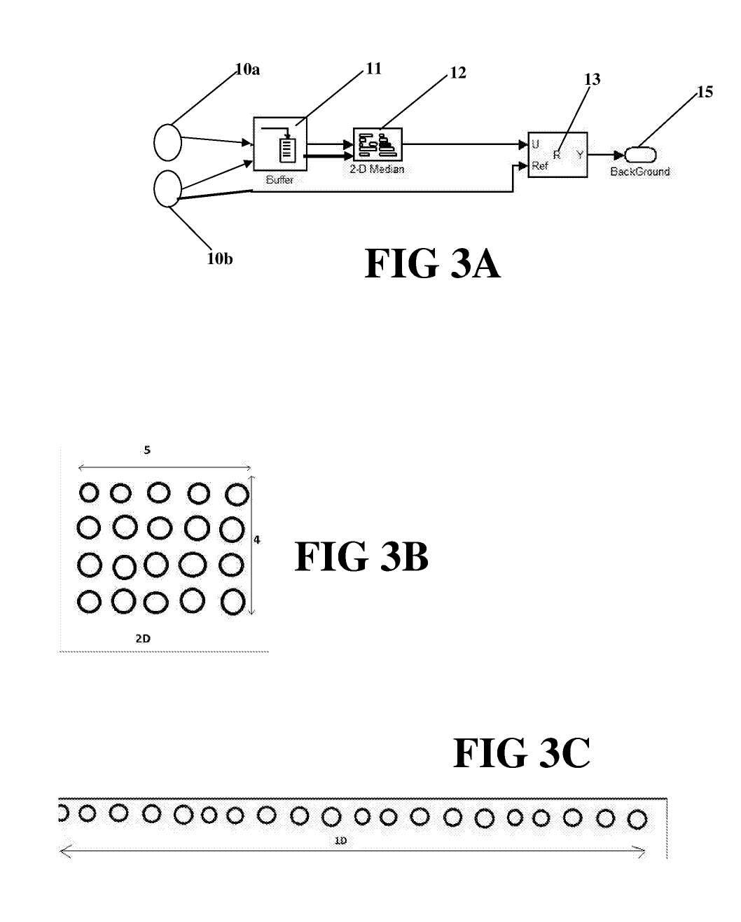

When a suspicious subject enters one of the system cameras field of view security personnel can mark the suspicious subject on the viewing screen causing the operation of a tracking system. The tracking system application is an application software generally on the same processing means that enables marking a subject (with a computer mouse or with touch screen, or automatically by motion detection software etc.). Two sampled still images of the filming recording camera during the tracking (both images feature the tracked subject) are saved in the processing means during the tracking, and are analyzed. Each of said images comprise a foreground which relates to single objects within the image such as moving people, and a background at the areas which are not part of the moving objects foreground. According to a preferred embodiment, the processing means comprise a buffer 11 which transfers the still images into a 1-D signal, as shown in FIG. 3A. Two of the sampled image frames 10a and 10b are transferred to buffer 11 which transfers them into 1-D signals. An illustrative example of the pixels of the 2-D still images representation and the 1-D representation can be seen in FIGS. 3B and 3C respectively. The processing means comprise a 2-D median function buffer 12, which takes the two output 1-D signals and performs a median function on them, thus practically removing the moving object features from the 1-D signals and remaining with one image of the still background.

According to one embodiment, the median function includes finding a median threshold of the intensity values of the pixels of the image references (the set of frames 10a and 10b). The signals in the background portion of both frame images are almost identical. After performing the median function, generally, the pixels with intensity values beneath the threshold are considered the background portion. The pixels with intensity values above the threshold are considered the foreground portions. The pixel areas of the foregrounds of both images are assigned with the corresponding other image background values. In case of RGB images, the intensity is the value of the total amplitude of each pixel.

According to an embodiment of the present invention, the median threshold is the numerical value separating the higher half of a data sample from the lower half. For example, count(n) is the total number of observation items in given data. If n is odd then—

Median (M)=value of ((n+1)/2)th item term.

If n is even then—

Median (M)=value of [((n)/2)th item term+((n)/2+1)th item term]/2.

### Example

For an Odd Number of Values:

As an example, the sample median for the following set of observations is calculated: 1, 5, 2, 8, 7.

Firstly, the values are sorted: 1, 2, 5, 7, 8.

In this case, the median is 5 since it is the middle observation in the ordered list.

The median is the ((n+1)/2)th item, where n is the number of values. For example, for the list {1, 2, 5, 7, 8}, n is equal to 5, so the median is the ((5+1)/2)th item.

median=(6/2)th item

median=3rd item

median=5

For an Even Number of Values:

As an example, the sample median for the following set of observations are calculated: 1, 6, 2, 8, 7, 2.

Firstly, the values are sorted: 1, 2, 2, 6, 7, 8.

In this case, the arithmetic mean of the two middlemost terms is (2+6)/2=4. Therefore, the median is 4 since it is the arithmetic mean of the middle observations in the ordered list.

We also use this formula MEDIAN={(n+1)/2}th item. n=number of values

As above example 1, 2, 2, 6, 7, 8; n=6; Median={(6+1)/2}th item=3.5th item. In this case, the median is average of the 3rd number and the next one (the fourth number). The median is (2+6)/2 which is 4.

If A is a matrix, median(A) treats the columns of A as vectors, returning a row vector of median values.

Optionally, more than two images of the tracked subject can be inputted into the buffer 11 and 2-D median function 12, wherein a median function of the more than two images are calculated, producing a background image.

The still background image is transferred to a reshaping unit 13 along with the original image size of image 10b thus re-producing a complete 2-D background image 15.

Second Stage—Obtaining the Foreground of the Image

According to an embodiment of the present invention, the original image comprises a section within it, in the form of a certain shape (e.g. rectangle, circular portion, polygon, any closed shape) bounded by the user (by means of a computer mouse, etc.). The user bounds the portion in a manner such that the bounded portion preferably comprises only one head portion, i.e. the head of the person in the image being analyzed. The bounds are saved in the frame and will be used later on as will be explained hereinafter.

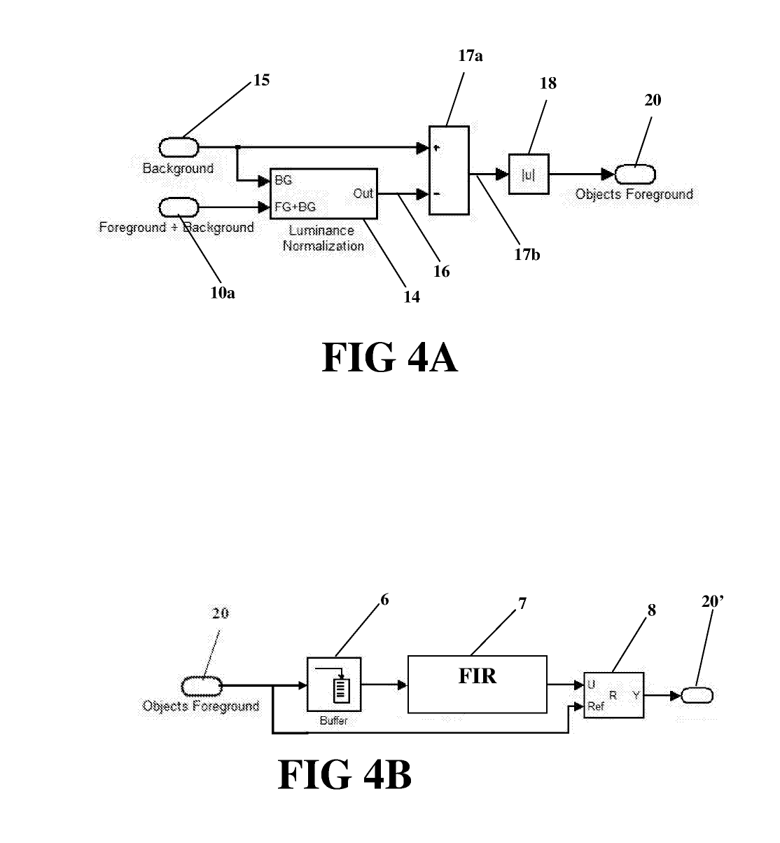

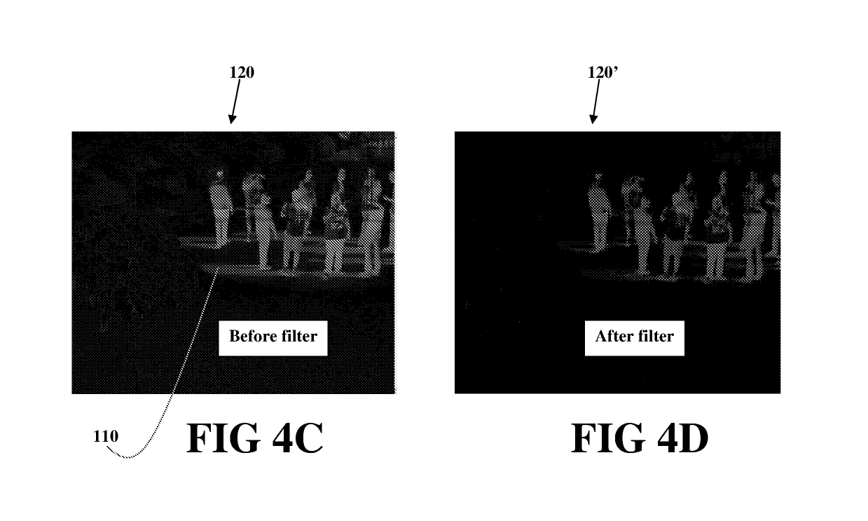

A luminance normalization is applied to the original image 10a such that its luminance is adjusted to the luminance of the complete background image 15, as shown in FIG. 4A. The processing means comprise a luminance normalization unit 14 which is adapted to change the luminance of one input image to that of another input image. The original image 10a and the complete background image 15 are transferred to the luminance normalization unit 14, which adjusts the luminance of image 10a to that of image 15. The output 16 of the luminance normalization unit 14 is subtracted from the background 15 by a subtracting unit 17a. The processing means comprise an absolute value function unit 18 which produces the absolute value of an input image. The result of the subtraction 17b (the output of subtracting unit 17a) is transferred to the absolute value function unit 18 and produces the absolute value of subtraction 17b. Consequently, an object foreground image 20 is obtained comprising the objects (e.g. people) of the original image.

Optionally, an improved object foreground 20′ can be obtained comprising improved objects (e.g. people) of the original image, as shown in FIG. 4B. The object foreground image 20 is transferred to buffer 6 which transfers it into a 1-D signal. The 1-D signal is transferred to FIR filter 7 which further filters noises of background portions. The mathematics filter implementation is like a classic FIR convolution filter:

$$y ( k ) = {\sum }_{n} u ( n - k ) * h ( k )$$

Wherein y—is the output signal, u is the input signal, h is the filter (array of coefficients, such as a Sobel operator filter), k is the filter element (of the array of coefficients), and n is an index number of a pixel. k and n are incremented by 1.

The filtered image is then transferred to a reshaping unit 8 along with the image size of image 20 thus re-producing a complete 2-D improved foreground image 20′.

FIGS. 4C and 4D show an example of an image 120 before the filtering, and of the image 120′ after the filtering. It is clear that background portions (e.g. ground portion 110) that appear in FIG. 4C do not appear in FIG. 4D.

Third Stage—Obtaining the Hair Portions of the Foreground Objects

The next stage comprises obtaining the hair portion of a person object in the image. Firstly, a new image 200 is obtained from the image foregrounds (20 or 20′) which comprises part of the image foregrounds (20 or 20′). The part of the image foregrounds that make image 200 is the area of the aforementioned bounded portion of the original image. Thus image 200 obtained is actually the aforementioned bounded portion area, but of the image foregrounds (20 or 20′).

Secondly, obtaining the head portion according to the head contour can be done by known functions in the art. One manner of obtaining the head portion is by using quantum symmetry groups theory for selecting suitable filters/templates such as Wavelet templates to be applied on the image. Optionally, an average of a group of Wavelet templates can be used.

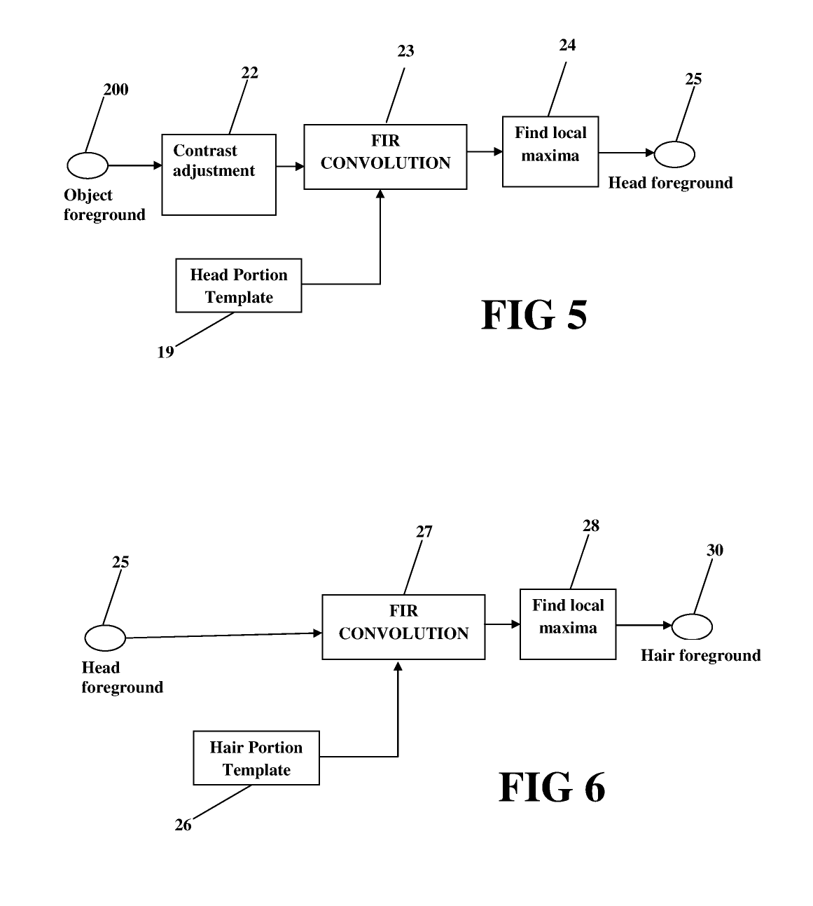

The object foreground one person image 200 comprises, among other portions, the one person head contour arc-formed portions. The processing means comprise a contrast adjusting unit 22 which adjusts the contrast of an image such that it becomes optimal as known in the art (shown in FIG. 5). The Contrast Adjustment unit adjusts the contrast of an image by linearly scaling the pixel values between upper and lower limits. Pixel intensity values that are above or below this range are saturated to the upper or lower limit value, respectively. The contrast adjustment unit provides the system with improved identification results.

The image 200 is transferred to the contrast adjusting unit (comprised in the processing means) which optimizes its contrast. Optionally the bounded portion can be taken after the contrast adjustment procedure mutandis mutatis.

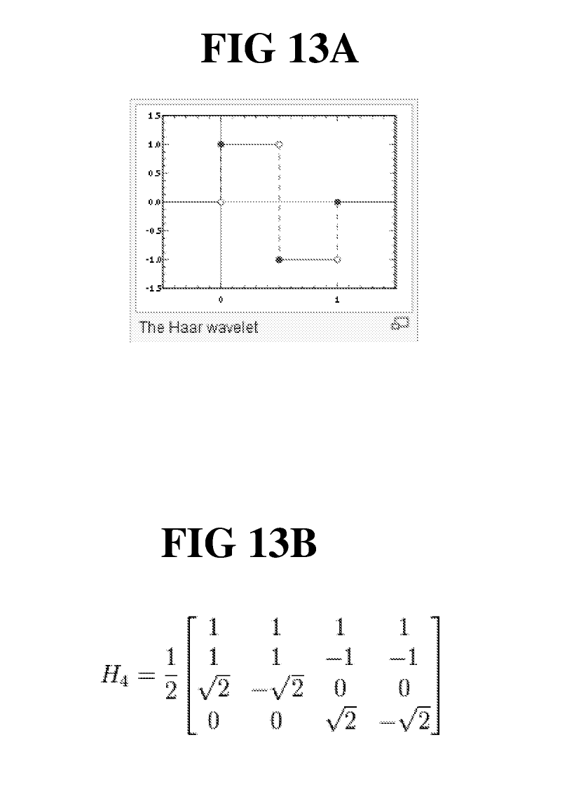

Appropriate filters/Wavelet templates can be used. For example, a general form of a “Haiar” wavelet (rectangle-like wave) can be seen in FIG. 13A. An example of a 4×4 Haar wavelet transformation matrix used (in the 4^{th} order) can be shown in FIG. 13B.

The output of the contrast adjusting is transferred to a FIR convolution unit 23 comprised in the processing means. The FIR convolution unit 23 convolves the contrast adjusted image with a selected Wavelet head portion template 19 in a FIR manner (similarly as explained hereinabove) producing the image with an additional coefficients matrix dimension, wherein each image pixel has a corresponding coefficient of said matrix. The mathematics filter implementation is like classic FIR convolution-decimation filters:

$$y ( k ) = {\sum }_{n} u ( n - k ) * h ( k )$$

Wherein y—is the output signal, u—input signal, h—is the filter coefficients, k, n—indexes where the index k is incremented by 1, and index n—is incremented by Decimation factor, which is changing from 1 to 2̂(Wavelet Levels Number).

The portions of the image with high coefficients (in the additional coefficients matrix dimension) are the head portions of the foreground objects. The high coefficients are produced due to the compliance of the image arc head portions and the template 19 characteristics. A Local Maxima function unit 24 (comprised in the processing means) cuts off the image pixels/portions with the low coefficients, thus remaining with an image 25 featuring the head contour arc-formed portion of the foreground object. The image 25 is a rectangular image comprising a constant number of pixels that comprise the head image obtained leaving a small margin beyond the head portion. Optionally, the low coefficients pixels/portions left in rectangular image 25 are zeroed or alternatively are remained with the same values. Optionally, the head portion image 25 is enlarged/reduced by known scaling techniques for more efficient analysis.

The next stage comprises obtaining the hair portions of the arc head portions, as shown in FIG. 6. A hair position template 26 (optionally selected in a similar manner as above e.g. from Wavelet templates), when applied, is adapted to cut off the lower portions of the head arcs and remain with the upper portions where the hair location is.

The head foreground image 25 is transferred to a FIR convolution unit 27 comprised in the processing means. The FIR convolution unit 27 convolves the head foreground image 25 with the selected Wavelet hair portion template 26 in a FIR manner producing the image with an additional coefficients matrix dimension, wherein each image pixel has a corresponding coefficient of said matrix. The portions of the image with high coefficients (of the additional coefficients matrix dimension) are the hair portions. The high coefficients are produced due to the compliance of the image hair portions and the template 26 characteristics. A Local Maxima function unit 28 (comprised in the processing means) cuts off the image portions with the low coefficients, thus remaining with an image 30 featuring the hair portion of the foreground object. The image 30 is a rectangular image comprising a constant number of pixels that comprise the hair image obtained leaving a small margin beyond the hair portion. Optionally, the low coefficients pixels/portions left in rectangular image 30 are zeroed or alternatively are remained with the same values. Optionally, the hair portion image 30 is enlarged/reduced by known scaling techniques for more efficient analysis.

Optionally, the hue of the image can be adjusted during the process to improve results.

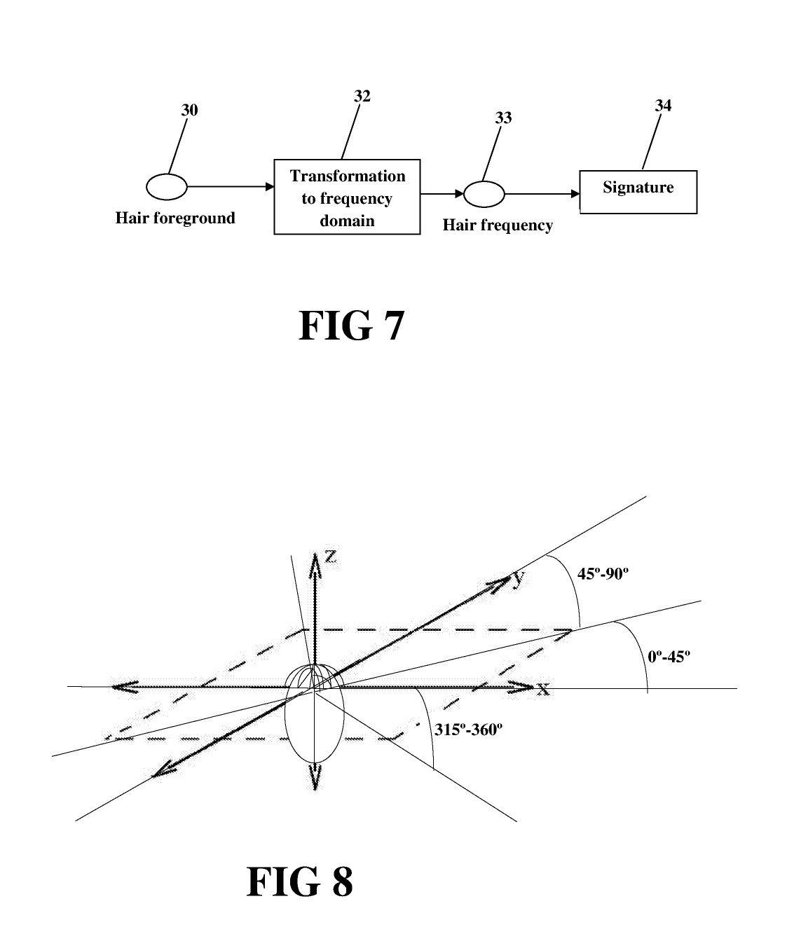

Then, image 30 is transferred to a transformation to frequency domain unit 32 (comprised in the processing means), which transforms it to the frequency domain (e.g. by Fourier transformation, Short Fourier Transforms, Wavelet Transforms or other transformation methods) producing the final frequency image 33 as shown in FIG. 7. Finally, a signature 34 is performed on image 33 saving image 33 and its characteristics of the hair frequencies in the system memory/database.

The term “signature”, or “signatured” or “signed” (in past tense) refer to saving the image in the processing means database under a certain name/identification.

Strengthening the Reliability of the Signature

After the first signature is obtained, the subject person is tracked within the field of view of the present camera that it is in its field of view. For this, standard tracking methods are used, for example people tracking by background estimation and objects movement detection.

According to the direction of movement of a person, the system can figure out the general head orientation facing the camera by calculating the direction—optical flow line—of a subject tracked and sampled at two locations. The direction is the optical flow line measured between both sampled areas. The head orientation is calculated accordingly. In general, the direction of movement is where the distal front portion of the head is. If a person moves leftwards in relation to the camera view then his left portion of his head is shown. If a person moves rightwards in relation to the camera view then his right portion of his head is shown. If a person moves away from the camera then his back portion of his head is shown. If a person moves towards the camera then his front portion of his head is shown.

The system tracks the person and samples his hair again, as described hereinabove. The signature features of the second sampling group are saved additionally under the same signature of the first sampling group. In general, the hair features in the frequency domain are similar with all of the head orientations, and can be used accordingly for identification

Even though, two groups of samples of similar orientations particularly produce very close results.

The present invention system is adaptive, i.e. it takes multiple samples and corrects its signature features according to the feedback received from the later samples. This improves the coherence (and credibility/reliability) of the signature. The final signature can be an average of the frequency properties of a few samples of the tracked person.

If during tracking the person changes direction of motion, then an additional sample group frequency domain image along with the new marked orientation (Region Of Interest—ROI) facing the camera is saved in the database under that particular person's signature. The database can save a particular subject person having samples in more than one Regions Of Interest under the same signature. For example, the signatures can comprise ROI groups of 6 or more ROIs per subject. In other words if the subject is tracked when moving diagonally than the ROI marked and saved can be for example Front-Left region, Front-Front, Back-Right, etc. FIG. 8 shows an example of 8 ROIs, each region being of 45°. Regions 0°-45°, 45°-90° and 315°-360° are clearly shown therein wherein the most front portion of the head is on the positive x-axis. The ROI most visibly facing the camera is the ROI marked and saved for that sample group.

When a subject is tracked moving in several directions and sampled (as explained hereinabove) in each direction, the reliability of the signatures increase. As long as the subject is still in one camera's field of view and tracked, additional samples can be taken. After a subject leaves the camera field of view the tracking ceases and no more samples can be taken for a certain subject at that stage even if the subject quickly returns to the camera field of view because there is no certainty that the subject is in fact the first subject once the tracking ceases. The tracked subject can be sampled on each frame, or every number of frames.

Identifying a Known Subject

The present invention enables identifying a new subject entering one of the system cameras field of view as being one of the signatured subjects. When a person enters a system camera field of view and is tracked and sampled the features of the now sampled hair is compared with the system database images previously saved therein by means of a comparing coherence function unit (comprised in the processing means). The coherence function of the two images being compared produces a result indicating how close both images are. For example, a positive match (identification) would be if the coherence function would indicate upon an 80% or 90% similarity between the images. A threshold percentage of similarity can be chosen by a system user wherein a percentage above the threshold indicates a positive identification and a percentage below the threshold indicates a negative identification.

The new subject is tracked (and thus an orientation ROI is determined) and then sampled. For an efficient fast identification, the frequency domain images taken from the new subject can be compared with the database's signatures of the particular orientation ROI of the new subject tracked. This can reduce the time of comparison with the signatures comprising several images with various orientation ROIs by comparing only with other images with similar orientation ROIs in the database.

In any case, as said, even the frequency characteristics of one subjects hair in one region of interest would produce a high coherence and positive identification with another image of that same subject even when facing a different ROI and/or from a different image distance. Two images with the same subject and same ROI tipically produces merely a better coherence.

Optionally, if a number of images were saved in a subject's signature at several ROIs and a new image with hair in a different ROI of those of that subject is being compared with the database an average of the various frequency images can be compared with the new image. Particularly, the average of various ROIs increases obtaining good results with people with unsymmetrical heads.

According to a preferred embodiment, at the time of the image hair measurement of a subject, the hair of a secondary subject in the same image is measured concurrently and both are “signed” as explained hereinabove. After both signatures are obtained, the frequency domain images of both “signed” hair images are compared (by coherence). The coherence comparison includes analyzing the two frequency domain images in various frequency band levels. The frequency range of each level is divided into a number of frequency bands from a starting frequency point to a closing frequency point. Each image is compared by the coherence comparing function unit, one at each level. If the comparison of both images are similar (coherence above a certain percentage threshold) that level is “thrown away”, i.e. any future comparison with new images will be made only in the levels where the coherence of the above pair is not similar. This will save a substantial amount of calculation time and efforts. Nevertheless, if only one subject is in the camera field of view and such a comparison to find the appropriate levels is not possible, the future comparisons between the one subject image and the new image will be made at each level and only positive matches of each level between the two will be considered a positive identification match.

Optionally, if only one subject is in the camera field of view another image with hair of a subject of that same camera and same field of view can be used as the secondary subject. Or, a future image subject in the camera field of view can be used for obtaining the secondary subject for finding the relevant levels.

Optionally, a pre-set area in the camera field of view can be determined to have people moving in a singular direction and a pre-set head position can be fed into the system. This enables to determine the head orientation and analyze accordingly.

According to a preferred embodiment, the level band is between 0.1 kHz and 2.5 kHz. The number of accuracy frequency steps in the range are from 256-2048 (preferably 512).

The present invention enables personnel to mark a subject for analyzing and signature as explained hereinabove and also enables an automatic marking, analysis and signature of subjects entering a field of view and automatic comparison with the database. Furthermore, hair color (according to the RGB properties), hats, bald portions, colored shirts, pants, printed pattern and other characteristics of subjects that can be measured easily by RGB or pattern analysis, as well, can also be saved together with the signature for efficient comparison and pre-filtering, thus shortening and reducing the processor requirements, the identification comparison process, e.g. if black hair is signed and blond hair is currently detected and compared with the database elements, the RGB properties of the blond hair are compared with the RGB properties of the database. Once the color comparison results in a mismatch the frequency comparison will not commence with that black haired signature subject (thus producing a negative identification result) saving processor time.

For improving results in additional to the described above, methods of using 3D-Image representation, mapping and techniques from Theory of Groups symmetry and quantum mechanics/radiophysics can be used.

The present invention also includes the hair ROI being marked manually and compared either automatically or manually to another image photograph in a similar manner as explained hereinabove. When marked manually, there is no need to find a foreground, background, etc., but the marked portion can be directly transformed to the frequency domain and signed (or the marked portion can be partially processed, i.e. luminance, contrast, etc.). The invention can be used for identification of people in still photographs without any need for a tracking system. Moreover, when enough computer power is present, each frame, or a frame once every N seconds (N being a natural number), can be analyzed without the use of tracking.

The present invention can be used to efficiently and quickly search for a specific person in a video, on-line or during a post event analysis. For example, if security forces have an image of a wanted suspicious subject, they can obtain his signature according to the present invention and compare with subjects (in video camera films or still images) hair frequency features. The present invention is especially efficient because several times a subject in an image/video is unidentifiable. The hair frequency features can enable a positive identification.

Another possible use of the system is for commercial analysis, connecting shoppers to a specific track through different shop departments, identifying the same shopper at the cash register and analyzing its purchases.

The present invention also enables continuous tracking of a subject moving through adjacent cameras fields of view. First the subject is tracked within the first camera field of view. After moving from one field of view to another, the subject is tracked photographed and the image is analyzed, sampled and compared to an image of a few seconds ago of the first camera. If a positive match is made (as explained hereinabove) then the subject tracked is considered the same subject as tracked before.

According to a preferred embodiment of the present invention, the signature can be used for tracking a subject in the following manner. After a signature is obtained from a person, the hair image is divided into an array of groups of a number of pixels in each group (or one pixel in each group). Each group is transformed into the frequency domain. A coherence comparison function is applied between each group frequency domain and the general image signature. The group with the highest coherence closest to the general image signature is chosen to be tracked. The tracking of the HCG (Highest Coherence Group) is executed in a manner wherein during each consecutive frame image (or each number of consecutive frame images) the surrounding groups of the first HCG area are transferred to the frequency domain and compared with the first found HCG frequency (or the general signature frequency image). If a high coherence is found between one of the now measured groups (second HCG) and the first found HCG frequency (or the general signature frequency image) then the tracking continues.

At the consecutive frame image (or a number of consecutive frame images) the surrounding groups of the second HCG area are transferred to the frequency domain and compared with the second HCG frequency (or the general signature frequency image). If a high coherence is found between one of the now measured groups (third HCG) and the second HCG frequency (or the general signature frequency image) then the tracking continues, and so on and so forth.

If during a consecutive frame image (or a number of consecutive frame images) a high coherence is not found in the surrounding groups (i.e. the coherence of all the surrounding groups checked are beneath a threshold) then the tracking system is searching for the high coherence in an area in the size of the possible movement of the subject in the given time frame between two frames. When found, the group with the high coherence is identified and tracking resumes.

When the tracked person exits the camera field of view and then returns to it, the person's hair is processed and signature and the tracking can resume optionally indicating that the person has returned and is once again being tracked.

The present invention enables to identify people at distant locations from the camera and perform a good signature according to the hair properties which can be positively compared to another signature of the same person. A system user can mark (e.g. on his screen) a portion of the hair in the image to be analyzed. A specific location of the hair which gives particularly good signatures and identification results is the area above the ears.

Analyzing the head morphology and hair qualities can also give indication of a person ethnic decent which can be helpful in commercial retail analysis and different security applications.

### Example

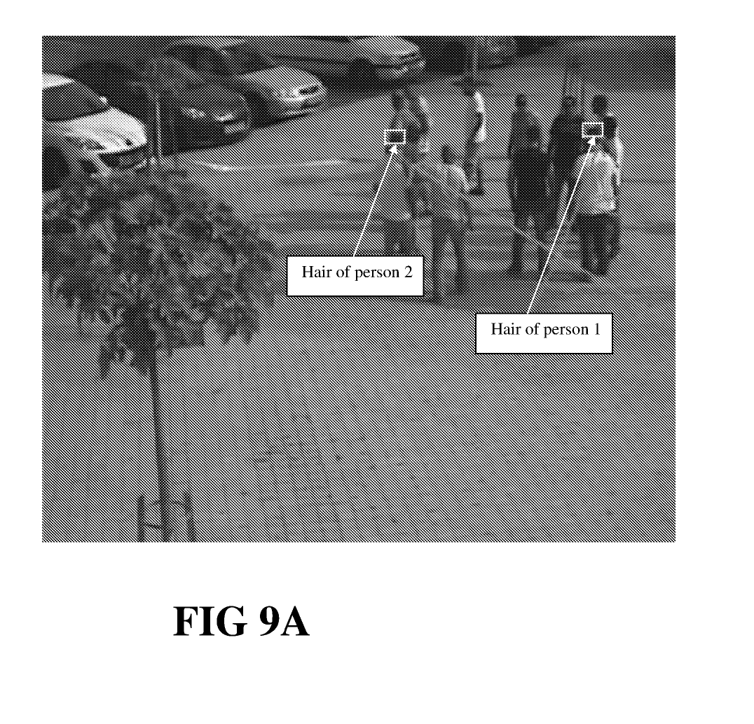

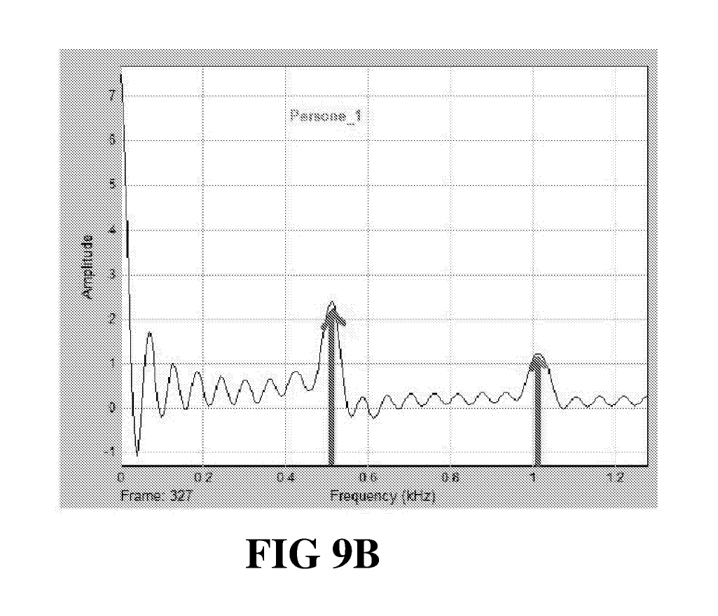

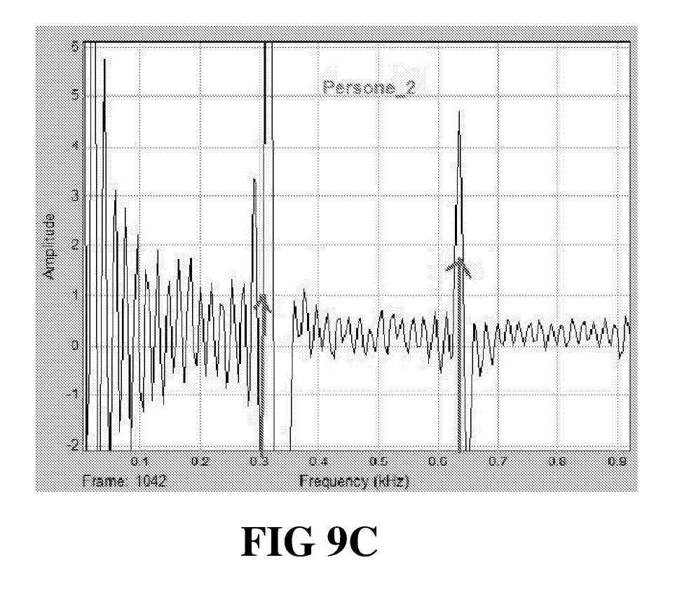

FIGS. 9A-9C demonstrate an example of the present invention. FIG. 9A shows an image from a camera. A hair portion (seen in the square boxes of two people in the image—person 1 and person 2) in the back-oriented position was analyzed. FIG. 9B shows the signature frequency/amplitude graph result of person 1. The frequency band level is between 0 kHz-3 kHz. Two frequency peaks are shown at around 0.5 kHz and 1 kHz. FIG. 9C shows the signature frequency/amplitude graph result of person 2. The frequency band level is between 0 kHz-3 kHz. Two frequency peaks are shown at around 0.3 kHz and 0.65 kHz.

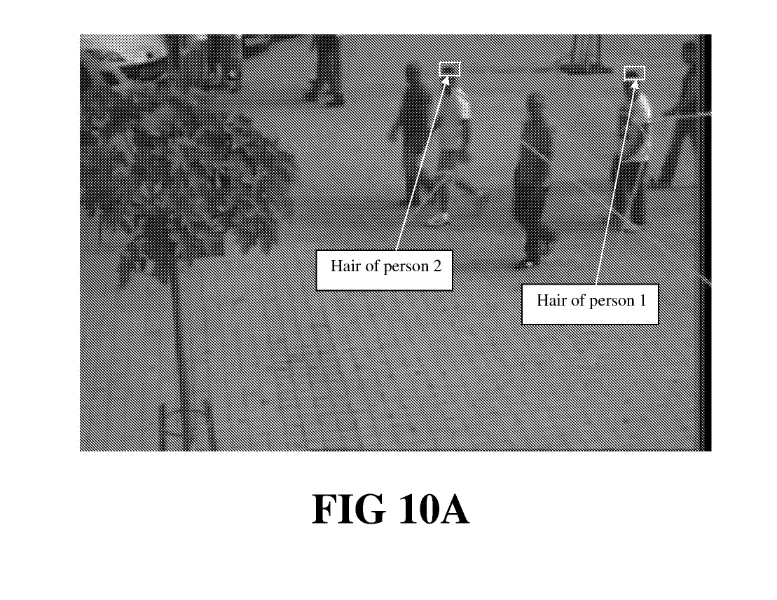

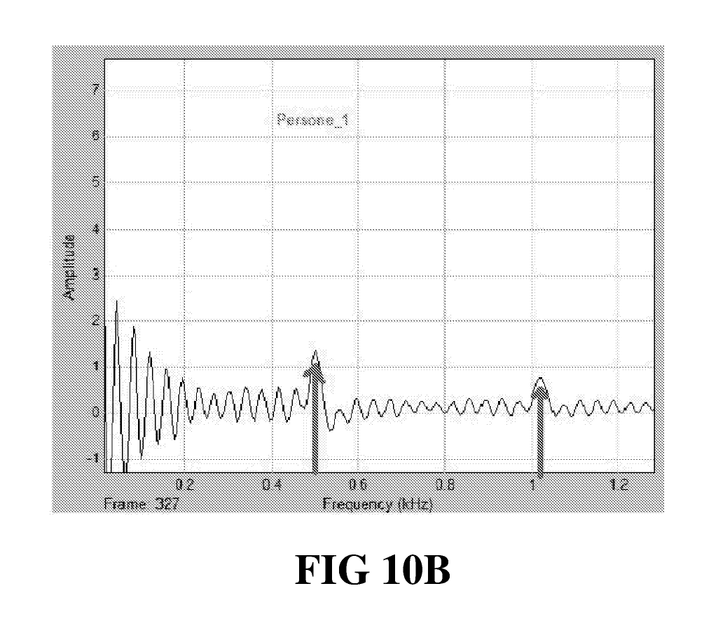

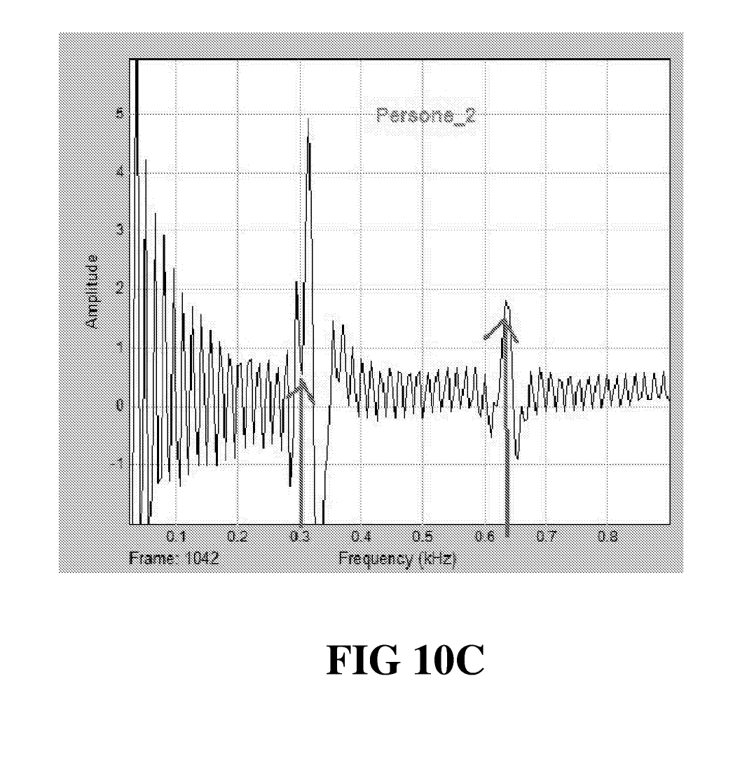

FIGS. 10A-10C demonstrate an example with the same sampled people of FIG. 9A. FIG. 10A shows an image from a camera. A hair portion (seen in the square boxes of two people in the image—person 1 and person 2, the same sampled people of FIG. 9A) in the front-oriented position was analyzed. FIG. 10B shows the signature frequency/amplitude graph result of person 1. The frequency band level is between 0 kHz-3 kHz. Two frequency peaks are shown at around 0.5 kHz and 1 kHz, just like in the back orientation sample. FIG. 100 shows the signature frequency/amplitude graph result of person 2. The frequency band level is between 0 kHz-3 kHz. Two frequency peaks are shown at around 0.3 kHz and 0.65 kHz, just like in the back orientation sample.

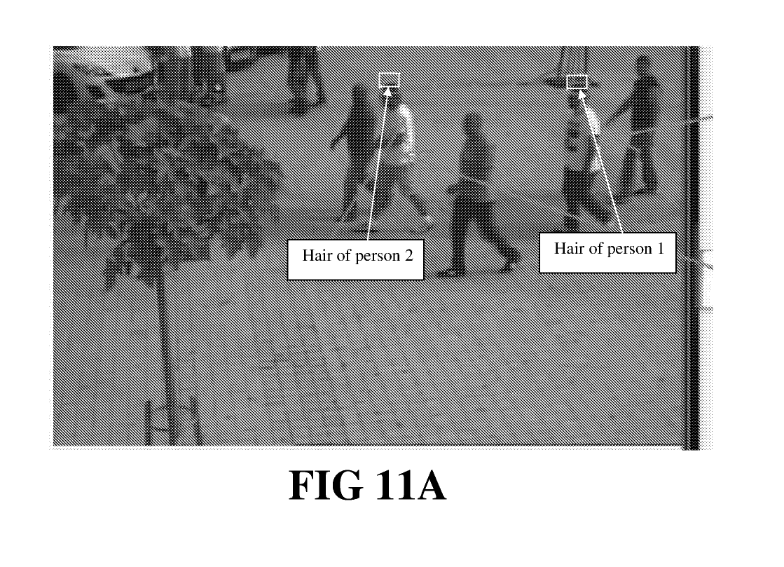

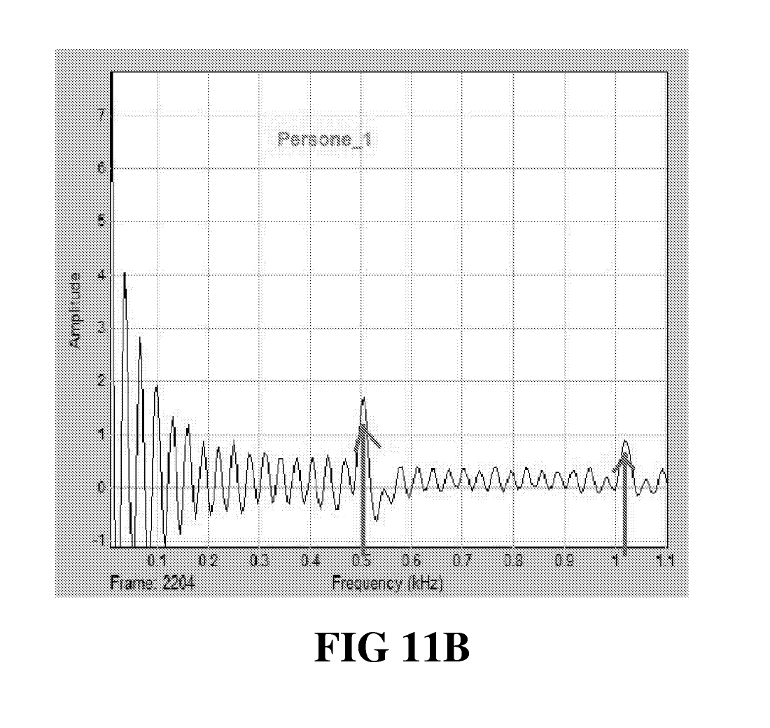

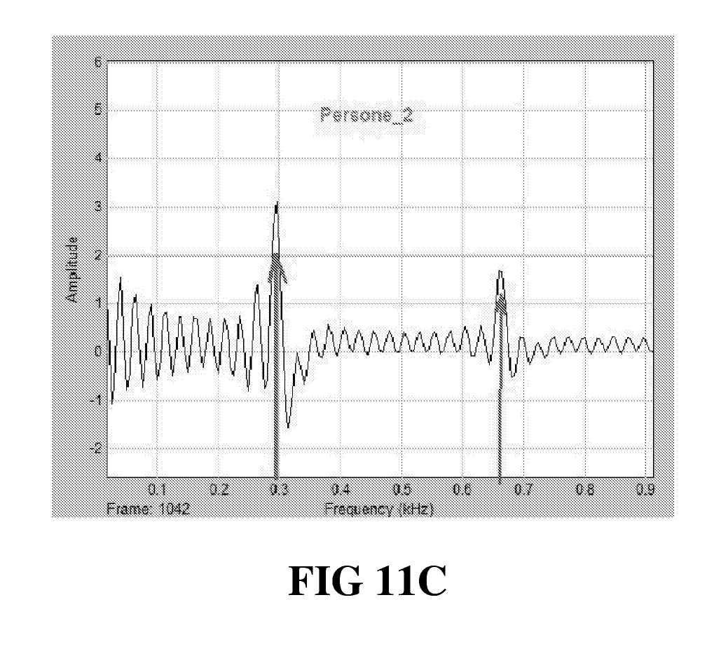

FIGS. 11A-11C demonstrate an example with the same sampled people of FIGS. 9A. and 10A. FIG. 11A shows an image from a camera. A hair portion (seen in the square boxes of two people in the image—person 1 and person 2, the same sampled people of FIGS. 9A and 10A) in the side-oriented position was analyzed. FIG. 11B shows the signature frequency/amplitude graph result of person 1. The frequency band is between 0 kHz-3 kHz. Two frequency peaks are shown at around 0.5 kHz and 1 kHz, just like in the back and front orientation samples. FIG. 11C shows the signature frequency/amplitude graph result of person 2. The frequency band level is between 0 kHz-3 kHz. Two frequency peaks are shown at around 0.3 kHz and 0.65 kHz, just like in the back and front orientation samples.

It can be seen that even if the peeks of all three graphs of person 1 are not of the same amplitude height and width the peaks are located approximately at the same frequency points. The coherence between the graphs is high. Similarly, the same thing goes for the graphs of person 2, wherein the frequency peek points are at different frequency points than those of person 1.

Artificial Background

According to another embodiment of the invention the low coefficients pixels/portions left in rectangular image 30 (i.e. the pixels on the space that is not the hair foreground) are assigned with an artificial background in order to increase accuracy of the Spectral Analysis. This is because the portion of image 30 which is not part of the hair (herein referred to as non-hair areas), when transformed to the frequency domain, affects the spectral properties of the signature. Different backgrounds of two frames negatively affect the signature coherence between the two frames even if the comprise similar hair portions. Providing similar artificial backgrounds improves the accuracy of the coherence comparison that follows.

The user chooses an appropriate artificial background (from a group of artificial background template images having the size of image 30) and assigns only the low coefficients pixels/portions left in rectangular image 30 with the corresponding pixels of the template background image. Thus an image of the hair foreground with artificial background is obtained. The image is transformed to the frequency domain thereafter.

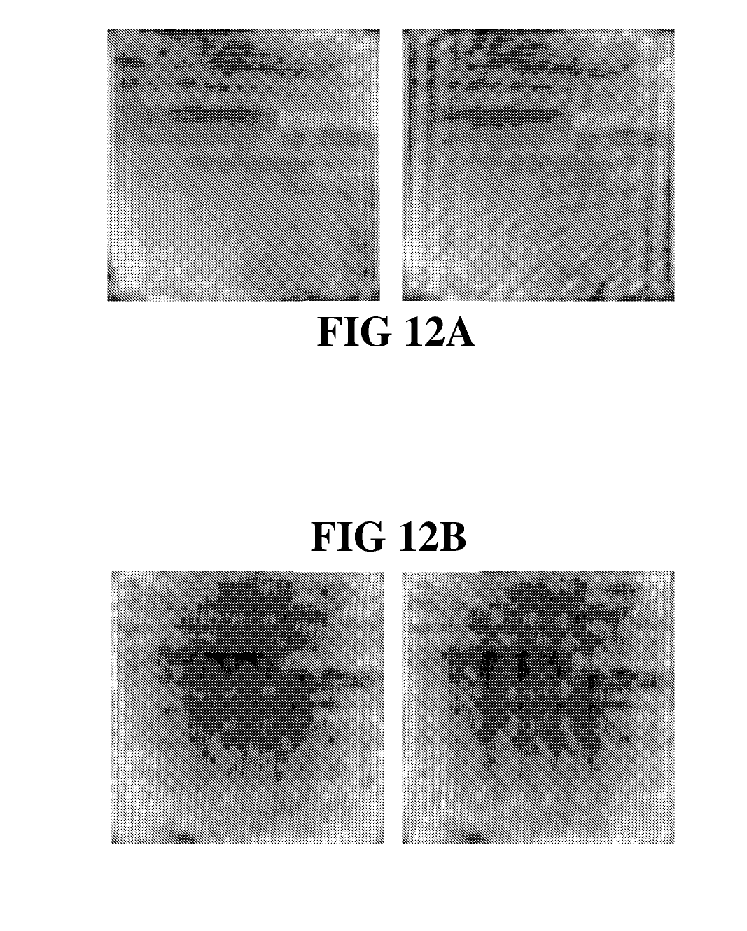

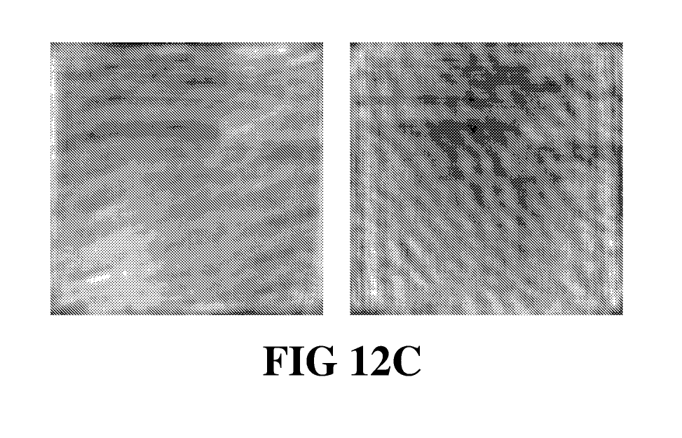

FIG. 12A shows frequency spectral properties of the same object in two different backgrounds without using the background replacing method. It can be seen that the general structure of spectral properties is different for different backgrounds even when relating to the same object. FIG. 12B shows frequency spectral properties of the same object using two same backgrounds (using the background replacing method). FIG. 12C shows frequency spectral properties of different objects using two same backgrounds. It can be seen that the general structure of the spectral properties is the similar for the same object (FIG. 12B) and it's different for the different objects (FIG. 12C).

Contour Analysis

When transforming image 30 into the frequency domain, the background, i.e. the portion of image 30 which is not part of the hair, when transformed to the frequency domain, affects the spectral properties of the signature. Also, the head position of a certain subject changes from various pictures. Sometimes the front side of the head faces the camera, sometimes the back side of the head faces the camera, and sometimes one of the two sides of the head face the camera. When comparing the signature of hair from different positions, there could be a great deal of missing essential information which leads to the un-correspondence (low coherence) between an original signature and a signature taken from the same person but at different head-position.

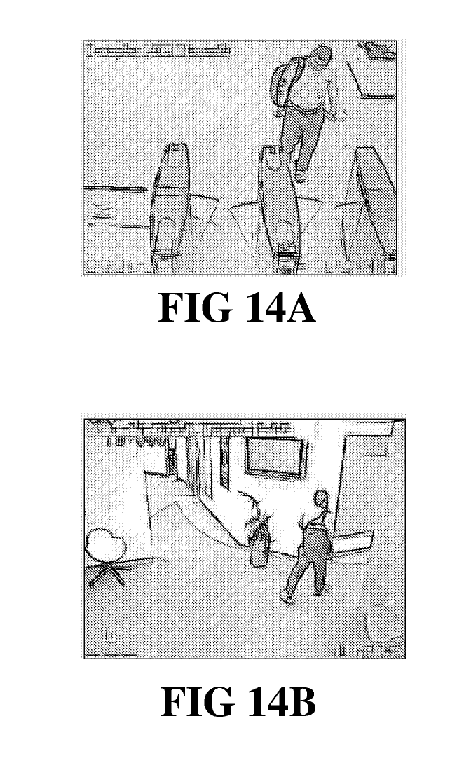

Therefore, according to another embodiment of the invention different portions of the hair foreground of image 30 are analyzed. It has been found that the coherence between the frequency spectral properties of similar sides of the hair portions is higher than that of hair between two different sides. Therefore, it has been found efficient to take three portions of the hair foreground (three portions of the front-side-back of the head of a subject, when his side faces the camera; or side-front-side when his front faces the camera; or side-back-side when his back faces the camera), and analyze their spectral frequency properties. For example, FIG. 14A shows a subject person at an angle facing the camera and FIG. 14B shows a subject person at an angle where his side faces the camera.

According to this embodiment a “strip” of the hair portion (herein referred to as contour strip) is taken, transferred to the frequency domain and signatured. Since there is no background inside the signature area of the contour strip, the spectral frequency properties is clearer, and there is no need for artificial backgrounds as explained in the embodiment hereinabove. This embodiment is very efficient even if the two images have very different backgrounds. Also, at least one of the side contours of the subject always appears in an image. At least one of the (preferably three) contour strips are taken from the side portion (either left or right) of a head, which has a high chance in being positively matched with another signatured side contour strip of the same subject within the database.

According to this embodiment, a function is applied on the hair foreground image 30 that identifies the hair (e.g. using the high coefficients dimension as explained hereinabove) and bounds the hair area. The hair area is divided into three zones, a left zone, a central zone and a right zone. At least one contour strip is taken from each zone. The contour strips can be comprised of a line of adjacent pixels in a certain direction (up/down, diagonal, etc) from one end of the zone to another.

First, the ratio between intensity values of the highest position pixel in the contour strip and the lowest position pixel in the contour strip is calculated. Then the contour strip is transformed into the frequency domain and signatured while further comprising the highest-lowest pixels intensity ratio value. The three frequency domain strips are saved in the system memory/database, each along with its aforementioned found intensity ratio, all signatured under the same subject person.

During the identification process, the signatures are compared (producing high/low coherences in a similar manner as explained hereinabove) in order to find a matching identification. When comparing a certain subject with a database subject, the comparison begins with finding the two closest intensity ratios, i.e. the frequencies of the strips with the two closest intensity ratios (one from said certain subject the other from said database subject) are compared. If the frequency spectral properties are above a certain threshold, a positive identification is determined. If the frequency spectral properties are beneath a certain threshold, a negative identification is determined.

If the frequency spectral properties are between these two thresholds, than the contour strip is slightly shifted to the side, i.e. a new contour strip is taken adjacent to the first certain subject contour strip. The new contour strip is transformed into the frequency domain and compared with the same frequency domain strip of the database subject. If the frequency spectral properties are above a certain threshold, a positive identification is determined. If the frequency spectral properties are beneath a certain threshold, a negative identification is determined.

Optionally, if the frequency spectral properties are still between two thresholds, the comparison can continue by again shifting the strip, and so on and so forth until some predefined end-shift position. Preferably the end-shift location is before reaching the middle of the distance between two initial strips.

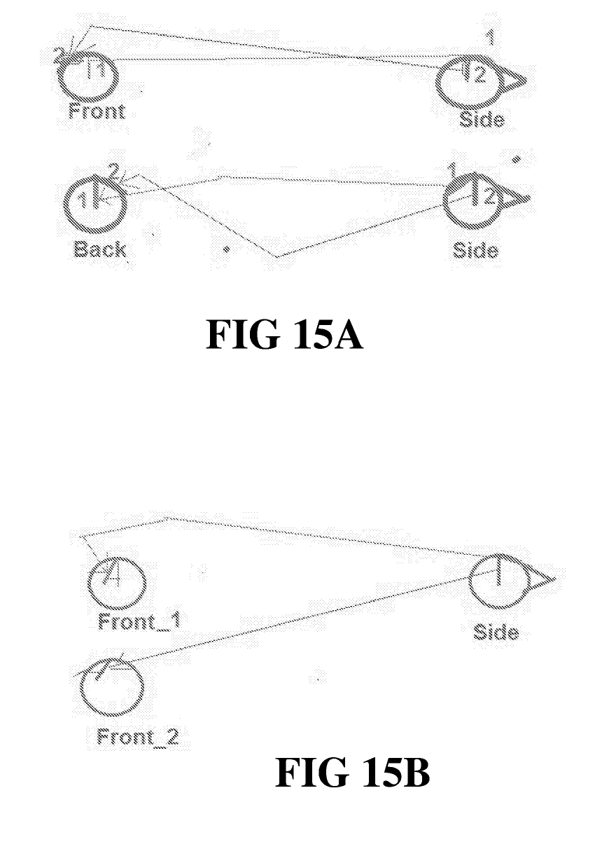

In any case, one of the three contour strips is a “side contour strip” taken from the side hair of a subject, regardless of the head orientation. FIG. 15A shows an example of a front/back contour strip 1 taken, and a side contour strip 2 taken (the triangle represents the nose).

FIG. 15A shows “ideal” correspondence between strips when at the moment of taking the signature the person was in a clear side-position (90 degrees from the camera) and at the moment of taking the signature where the person was in a clear front/back position (0 or 180 degrees from the camera). This situation can exist but it covers only particular “ideal” case.

FIG. 15B shows the case when at the moment of identification of the contour the person head position is not exactly the ideal front/back or side oriented position. It shows some intermediate position between front and side (or back and side) position.

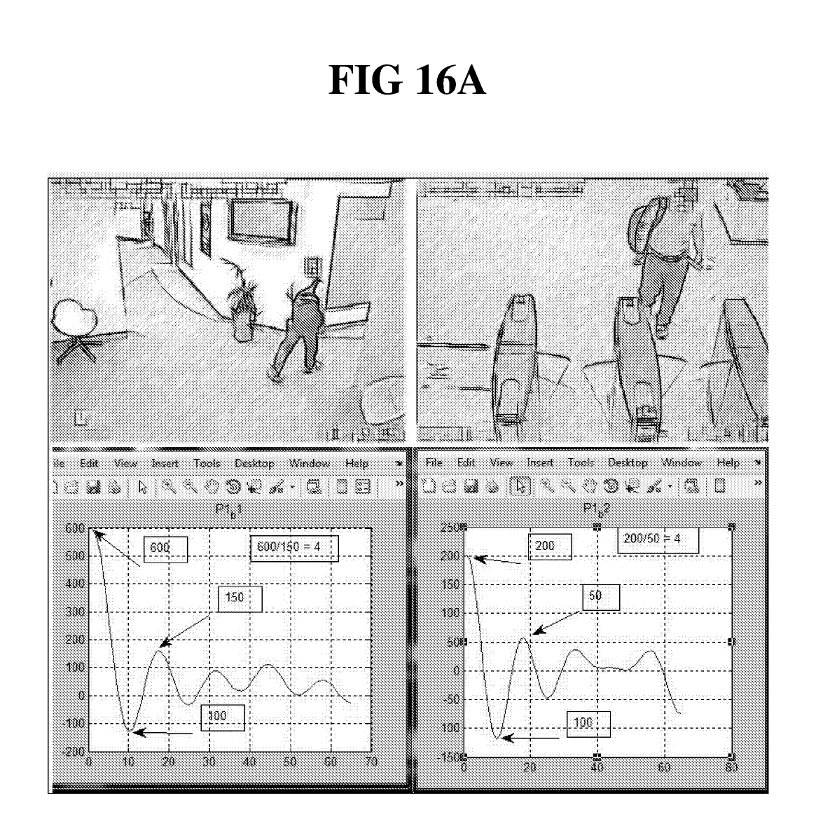

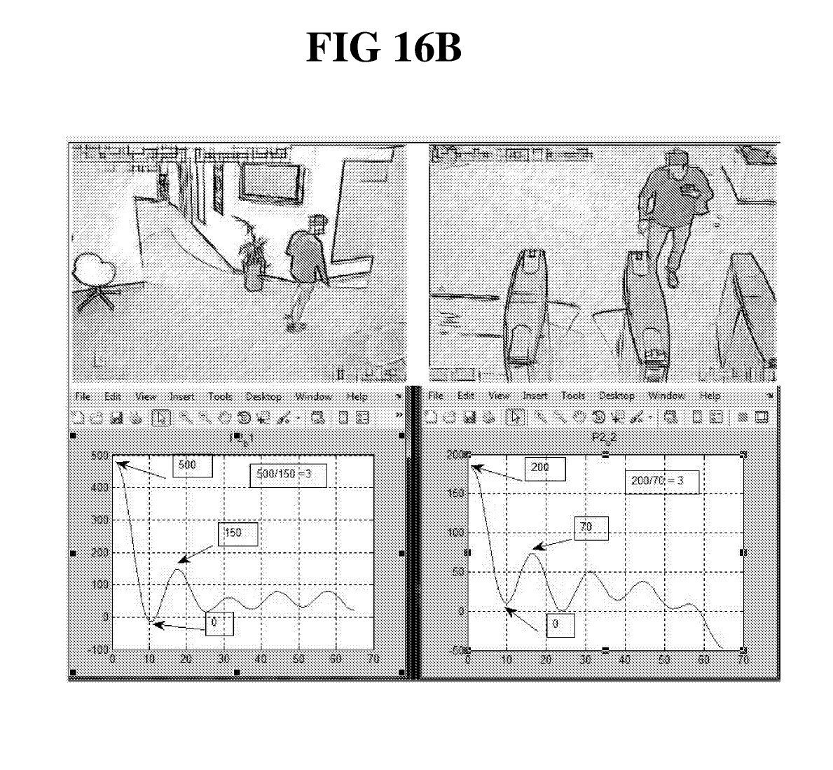

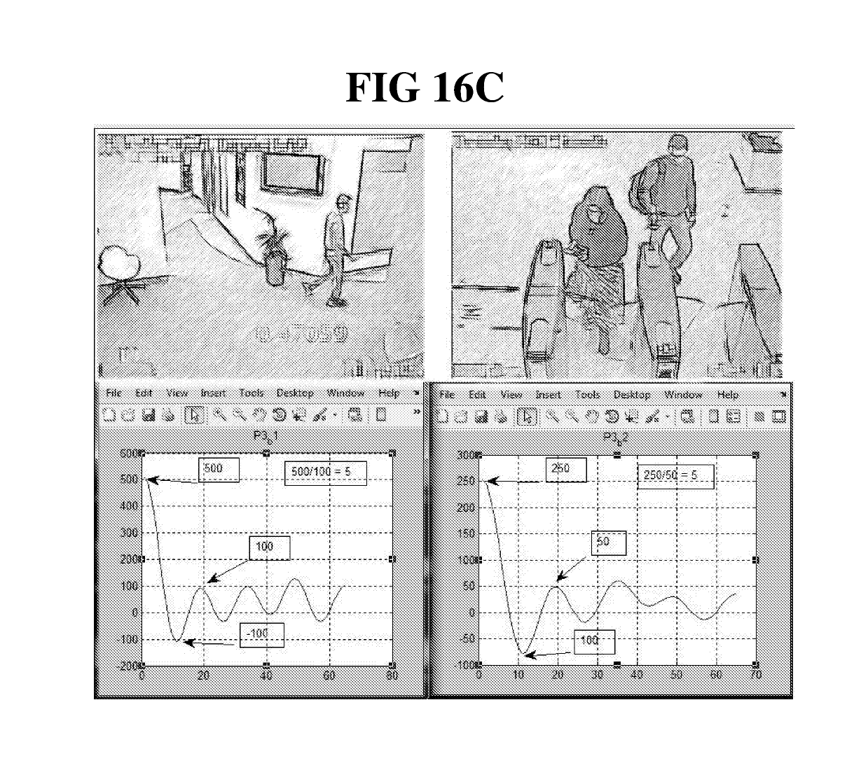

FIG. 16A shows an example of a comparison between side contour strips of the same person subject at two different head positions and at two different backgrounds (different cameras). Each of the strips' frequency domains are shown in the graphs beneath each image respectively. The frequencies are represented on the x axis and the amplitudes of the frequency on the y axis. It can be seen that the spectral characteristics (such as harmonics (peeks), ratio between first and second harmonics levels and minimum level, for example) are the same regardless of the head position in the image. FIGS. 16B and 16C illustrate similar examples of that of FIG. 16A, with different people, head positions, and spectral characteristics.

The present invention is related to a method for identifying a person comprising the following steps:

A) obtaining an image of a person;
B) obtaining a hair portion of the person in the image;
C) Transforming the hair portion image into the frequency domain and preferably saving it in a database;
D) Comparing the obtained frequency domain image of step C with frequency domain images in the database, wherein an identification result is deemed to be positive when the coherence between both compared frequency domain images is above a certain threshold.

According to a preferred embodiment, the hair portion of step B) is obtained using one or more of the following steps:
a. obtaining first and second still images from a camera, the second image taken shortly after the first;
b. transforming the images into 1-D signals;
c. performing a 2-D median function on the signals of step b;
d. reconstructing a background 2-D image featuring the signal of step c and the size of the images of step a;
e. adjusting the luminance of one of the images of step a to the luminance of the background image of step d; wherein said one of the images of step a comprises a bounded portion (preferably bounding at least one head portion of a subject);
f. subtracting the image of step e from the image of step d (or vice versa);
g. perform an absolute value function on the image of step f to receive an object foreground;
h. obtaining a new image being a portion of the object foreground, wherein said portion of the object foreground is at the location corresponding to the location of the bounded portion mentioned in step e.
i. performing a FIR convolution on the image of step h with a head portion template to receive the image of step h further comprising an additional dimension with coefficient values corresponding to each image pixel;
j. obtaining a new image being a portion of the image of step i, wherein said portion of the image of step i comprises the pixels with the corresponding coefficient values above a threshold;
k. performing a FIR convolution on the image of step j with a hair portion template to receive the image of step j further comprising an additional dimension with coefficient values corresponding to each image pixel;
l. obtaining a new image being a portion of the image of step k, wherein said portion of the image of step k comprises the pixels with the corresponding coefficient values above a threshold.

According to one embodiment, the image of step g is further processed by transferring the image into a 1-D signal, and passing the signal through a FIR filter which further filters noises of background portions, and reconstructs a 2-D image featuring the signal exiting the FIR filter and the size of the images of step g. Optionally, a contrast adjustment is performed on it afterwards.

According to another embodiment of the present invention, the image of step l is further modified by assigning an artificial background to pixels with the corresponding coefficient values below the threshold.

The present invention relates to a method for tracking a person, comprising the following steps:
A) obtaining an image of a person from a video camera;
B) obtaining a hair portion of the person in the image;
C) transforming the hair portion image into the frequency domain and saving it in a database;
D) dividing the image of step B into an array of groups of pixels;
E) transforming each group of step D into the frequency domain;
F) comparing the coherence between each group frequency domain of step E and the frequency image of step C;
G) obtaining the group with the highest coherence closest to the image of step C;
H) obtaining the consecutive frame of the camera (or number of frames);
I) dividing the image of step H into an array of groups of pixels similar to the array of step D, and mark the surrounding groups of the location of the highest coherence group of its previous frame (or previous number of frames);
J) transforming each group of step I into the frequency domain;
K) comparing the coherence between each group frequency domain of step J and the frequency image of step C (or the previous frame(s) highest coherence group);
L) obtaining the group with the highest coherence closest to the image of step C (or the previous frame(s) highest coherence group);
M) if the coherence of step L is above a threshold, then steps H-M are repeated; if the coherence of step L is beneath a threshold, then the tracking ceases.

While some of the embodiments of the invention have been described by way of illustration, it will be apparent that the invention can be carried into practice with many modifications, variations and adaptations, and with the use of numerous equivalents or alternative solutions that are within the scope of a person skilled in the art, without departing from the spirit of the invention, or the scope of the claims.

1. A method for generating and comparing a biometric singular signature of a person comprising the following steps:
A) obtaining a first image of a person;
B) obtaining a hair portion image of the person;
C) transforming the hair portion image into its frequency domain image and optionally saving said frequency domain image in a database.

2. A method according to claim 1 further comprising a step of identification by comparing the obtained frequency domain image of step C with frequency domain images in the database, wherein an identification result is deemed to be positive when the coherence between both compared frequency domain images is above a certain threshold.

3. The method according to claim 2, wherein the hair portion image of step B) is obtained by further comprising one or more of the following steps:
a. obtaining a second image from a camera taken shortly after or shortly before the first image;
b. transforming the first and second images into 1-D signals;
c. performing a 2-D median function on the signals of step b;
d. reconstructing a background 2-D image featuring the signal of step c and the size of the first and second image;
e. obtaining the first or second image and adjusting its luminance to the luminance of the background image of step d; wherein obtained image comprises a bounded portion;
f. subtracting the image of step e from the image of step d (or vice versa);
g. perform an absolute value function on the image of step f to receive an object foreground;
h. obtaining a new image being a portion of the object foreground, wherein said portion of the object foreground is at the location corresponding to the location of the bounded portion mentioned in step e.
i. performing a FIR convolution on the image of step h with a head portion template to receive the image of step h further comprising an additional dimension with coefficient values corresponding to each image pixel;
j. obtaining a new image being a portion of the image of step i, wherein said portion of the image of step i comprises the pixels with the corresponding coefficient values above a threshold;
k. performing a FIR convolution on the image of step j with a hair portion template to receive the image of step j further comprising an additional dimension with coefficient values corresponding to each image pixel;
l. obtaining a new image being a portion of the image of step k, wherein said portion of the image of step k comprises the pixels with the corresponding coefficient values above a threshold.

4. The method according to claim 2, wherein step C comprises performing a signature by saving the frequency domain image in the database and providing it with identification.

5. The method according to claim 3, wherein the image of step g is further processed by transferring the image into a 1-D signal, and passing the signal through a FIR filter which further filters noises of background portions, and reconstructing a 2-D image featuring the output signal of the FIR filter and the size of the image of step g.

6. The method according to claim 3, wherein a contrast adjustment is performed on the object foreground after step g.

7. The method according to claim 3, wherein the image of step 1 is further modified by assigning artificial background values to the pixels with the corresponding coefficient values below the threshold.

8. A method for identifying a person comprising the following steps:
A) obtaining a first image of a person;
B) obtaining a hair portion image of the person further comprising at least one of the following steps:
a. obtaining a second image from a camera taken shortly after or shortly before the first image;
b. transforming the first and second images into 1-D signals;
c. performing a 2-D median function on the signals of step b;
d. reconstructing a background 2-D image featuring the signal of step c and the size of the first and second image;
e. obtaining the first or second image and adjusting its luminance to the luminance of the background image of step d; wherein obtained image comprises a bounded portion;
f. subtracting the image of step e from the image of step d (or vice versa);
g. perform an absolute value function on the image of step f to receive an object foreground;
h. obtaining a new image being a portion of the object foreground, wherein said portion of the object foreground is at the location corresponding to the location of the bounded portion mentioned in step e. i. performing a FIR convolution on the image of step h with a head portion template to receive the image of step h further comprising an additional dimension with coefficient values corresponding to each image pixel;
j. obtaining a new image being a portion of the image of step i, wherein said portion of the image of step i comprises the pixels with the corresponding coefficient values above a threshold;
k. performing a FIR convolution on the image of step j with a hair portion template to receive the image of step j further comprising an additional dimension with coefficient values corresponding to each image pixel;
l. obtaining a new image being a portion of the image of step k, wherein said portion of the image of step k comprises the pixels with the corresponding coefficient values above a threshold,
m. bounding the hair area;
n. dividing the hair area into three zones;
o. obtaining a contour strip from each of said zones, wherein said strip comprises a line of adjacent pixels in a certain direction from one edge of the zone to another;
p. calculating the ratio between intensity values of the highest position pixel in the contour strip and the lowest position pixel in the contour strip;
q. transforming the strips into frequency domain images and optionally saving said frequency domain images in a database being assigned to a certain subject;
r. comparing one of the obtained frequency domain images with frequency domain images of a subject in the database, wherein both frequency domain images compared are those with the closest intensity ratios; and wherein an identification result is deemed to be positive when the coherence between the two compared frequency domain images is above a first threshold and deemed to be negative when the coherence between the two compared frequency domain images is bellow a second threshold.

9. The method of claim 8 wherein if in step r the coherence result is between the first and second thresholds the following steps are taken:
s. obtaining a new contour strip by slightly shifting the obtained contour strip of step o;
t. transforming the new contour strip into the frequency domain and compared it with the same frequency domain strip of the database subject as in step r; wherein an identification result is deemed to be positive when the coherence between the two compared frequency domain images is above a first threshold and deemed to be negative when the coherence between the two compared frequency domain images is bellow a second threshold;
u. if in step t the coherence result is between the first and second thresholds, repeating steps s-u.

10. A method for tracking a person, comprising at least the first 3 of the following steps:
A) obtaining an image of a person from a video camera;
B) obtaining a hair portion of the person in the image;
C) transforming the hair portion image into the frequency domain and saving it in a database;
D) dividing the image of step B into an array of groups of pixels;
E) transforming each group of step D into the frequency domain;
F) comparing the coherence between each group frequency domain of step E and the frequency image of step C;
G) obtaining the group with the highest coherence closest to the image of step C;
H) obtaining the consecutive frame of the camera (or number of frames);
I) dividing the image of step H into an array of groups of pixels similar to the array of step D, and mark the surrounding groups of the location of the highest coherence group of its previous frame (or previous number of frames);
J) transforming each group of step I into the frequency domain;
K) comparing the coherence between each group frequency domain of step J and the frequency image of step C (or the previous frame(s) highest coherence group);
L) obtaining the group with the highest coherence closest to the image of step C (or the previous frame (s) highest coherence group);
M) if the coherence of step L is above a threshold, then steps H-M are repeated; if the coherence of step L is beneath a threshold, then the tracking ceases.

11. A system comprising one or more cameras connected to processing means,
wherein the processing means comprises:
A) a database;
B) a transformation to frequency domain unit;
C) a comparing frequency coherence function unit.

12. A method for generating a singular biometric signature comprising analyzing the hair/head structure of a given person in the frequency domain.

13. A method according to claim 12 where the hair/head structure analyzed is one or more contours of the head.

14. A method according to claim 13 further comprising a step of coherence comparison between two signatures made according to a method for generating a singular biometric signature comprising analyzing the hair/head structure of a given person in the frequency domain obtained from two different photographs.

15. A method according to claim 14 further comprising the step of calculating the intensity ratio between the intensity of the highest pixel in the contour and the intensity of the lowest pixel in the contour.

16. A method according to claim 15 further comprising the step of comparing the ratio calculated according to claim 15 between two sets of contours from at least two different photographs.

17. A method according to claim 16 further comprising comparing only the two contours with the highest coherence of the intensity ratios.

18. A system comprising two or more cameras connected to processing means,
wherein the processing means are configured to generate biometric signatures based on head/hair morphology of images obtained from said two or more cameras;
and configured to compare a signature from one camera to another camera to determine continuation of tracking.
